(19) United States
(12) Patent Application Publication
(10) Pub. No.: US 2019/0057715 A1
(43) Pub. Date: Feb. 21, 2019

(54) DEEP NEURAL NETWORK OF MULTIPLE AUDIO STREAMS FOR LOCATION DETERMINATION AND ENVIRONMENT MONITORING

(71) Applicant: POINTR DATA INC., San Jose, CA (US)

(72) Inventors: Saran Saund, Mountain View, CA (US); Nurettin Burcak Beser, Palo Alto, CA (US); Paul Aerick Lambert, Mountain View, CA (US)

(21) Appl. No.: 16/103,560

(22) Filed: Aug. 14, 2018

Related U.S. Application Data
(60) Provisional application No. 62/545,843, filed on Aug. 15, 2017.

(51) Int. Cl. G10L 25/48; G06N 3/08; G10L 25/30; G10L 21/0208

(52) U.S. Cl. CPC G10L 25/48; G10L 21/0208; G10L 25/30; G06N 3/084

(57) ABSTRACT

A system for monitoring an environment is disclosed. In various embodiments, the system includes an artificial neural network; a plurality of microphones positioned about the environment, the plurality of microphones configured to feed one or more audio signals to an input layer of the artificial neural network; and a first camera positioned within the environment, the first camera configured to determine location data for input to the artificial neural network.

### CROSS-REFERENCE TO RELATED APPLICATIONS

This application claims priority to, and the benefit of, U.S. Prov. Pat. Appl., Ser. No. 62/545,843, entitled “Deep Neural Network Analysis of Multiple Audio Streams for Location Determination and Environment Monitoring,” filed on Aug. 15, 2017, the entirety of which is incorporated herein for all purposes by this reference.

### FIELD

The present disclosure relates to systems and methods for monitoring indoor and outdoor environments and, more particularly, to systems and methods for monitoring customer behavior in high-foot traffic areas such as retail environments.

### BACKGROUND

Imaging of indoor and outdoor environments, including, without limitation, retail environments, can serve multiple purposes, such as, for example, monitoring customer behavior and product inventory or determining the occurrence of theft, product breakage or dangerous conditions within such environments. Cameras located within retail environments are helpful for live monitoring by human viewers, but are generally insufficient for detecting information on a broad environment-wide basis, such as, for example, whether shelves require restocking or whether a hazard exists at specific locations within the environment, unless one or more cameras are fortuitously directed at such specific locations and an operator is monitoring the cameras. Systems and methods for providing environment-wide monitoring, without depending on constant human viewing, are therefore desirable.

### SUMMARY

A system for monitoring an environment is disclosed. In various embodiments, the system includes an artificial neural network; a plurality of microphones positioned about the environment, the plurality of microphones configured to feed one or more audio signals to an input layer of the artificial neural network; and a first camera positioned within the environment, the first camera configured to determine location data for input to the artificial neural network.

In various embodiments, the plurality of microphones includes at least three microphones configured to triangulate a location of a sound source. In various embodiments, the first camera is configured to rotate or translate with respect to a point of reference within the environment. In various embodiments, the location data is used to determine an error signal. In various embodiments, the artificial neural network is configured to use the error signal in a backpropagation procedure. In various embodiments, a second camera is positioned within the environment, the second camera being configured to determine second-location data for input to the artificial neural network.

In various embodiments, the system includes a pre-processor configured to filter noise from the one or more audio signals. In various embodiments, the artificial neural network is configured to identify a sound event and a location of the sound event within the environment. In various embodiments, a post-processor is configured to generate response signals in response to identification of the sound event and the location of the sound event. In various embodiments, the sound event originates from at least one of a refrigeration unit, a product breakage occurrence or a human utterance or movement. In various embodiments, the post-processor is configured to reorient the first camera in response to identification of the sound event and the location of the sound event. In various embodiments, the first camera is configured to rotate or translate with respect to a point of reference within the environment.

A method for training an artificial neural network to identity a source of sound and a location of the source of sound within an environment is disclosed. In various embodiments, the method includes the steps of generating an audio signal representing the source of sound and the location of the source of sound; providing the audio signal to an input layer of the artificial neural network; propagating the audio signal through the artificial neural network and generating an output signal regarding the source of sound and the location of the source of sound; determining an error signal based on the output signal and location data concerning the location of the source of sound; and backpropagating the error signal to update a plurality of weights within the artificial neural network.

In various embodiments, the step of generating the audio signal representing the source of sound and the location of the source of sound comprises receiving a plurality of audio signals from a plurality of microphones positioned within the environment. In various embodiments, the location data is determined by a camera positioned within the environment. In various embodiments, the camera is configured to translate with respect to a point of reference within the environment. In various embodiments, the error signal comprises information based on the source of sound.

A system for monitoring an environment is disclosed. In various embodiments, the system includes a data processor, including an artificial neural network, a pre-processor to the artificial neural network and a post-processor; a plurality of microphones positioned about the environment, the plurality of microphones configured to feed one or more audio signals to the pre-processor to filter the one or more audio signals prior to being fed to an input layer of the artificial neural network; and a first camera positioned within the environment, the first camera configured to determine location data for input to the artificial neural network.

In various embodiments, the location data is used to determine an error signal and the artificial neural network is configured to use the error signal in a backpropagation procedure. In various embodiments, the artificial neural network is configured to identify a sound event and a location of the sound event within the environment and the post-processor is configured to generate response signals in response to identification of the sound event and the location of the sound event.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A is a schematic view of a system for monitoring an environment, such as, for example, a retail environment, in accordance with various embodiments;

FIG. 1B is a schematic view of an artificial neural network used in the system illustrated in FIG. 1A, in accordance with various embodiments;

FIG. 2 illustrates a method to identify a sound and its location within an environment to be monitored, in accordance with various embodiments;

FIG. 3 illustrates a method to pre-process audio signals used in identifying a sound and its location within an environment to be monitored, in accordance with various embodiments; and

FIG. 4 illustrates a flowchart describing steps used to identify a sound and its location within an environment to be monitored, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Described herein are devices, systems, and methods for monitoring indoor and outdoor environments, particularly indoor retail environments, such as, for example, retail stores and warehouses. The systems and methods may be used, for example, to monitor customer behavior, to monitor inventory of shelves of a store, or to monitor for hazardous situations, and the like. The devices, systems and methods may include sensors and may transmit detected data (or processed data) to a remote device, such as an edge or cloud network, for processing. In some embodiments, the edge or cloud network may be an artificial neural network and may perform an artificial intelligence algorithm using the detected data to analyze the status of the area being monitored. The edge or cloud network (or processor of the device, system or method) may output useful information such as warnings of potential hazards or whether a shelf is out of product or nearly out of product. The processor of the device, system or method may also determine whether a better point of view would be helpful (e.g., whether a particular view of the camera is impeded) and may control the device, system or method to change viewing perspectives to improve the data collection.

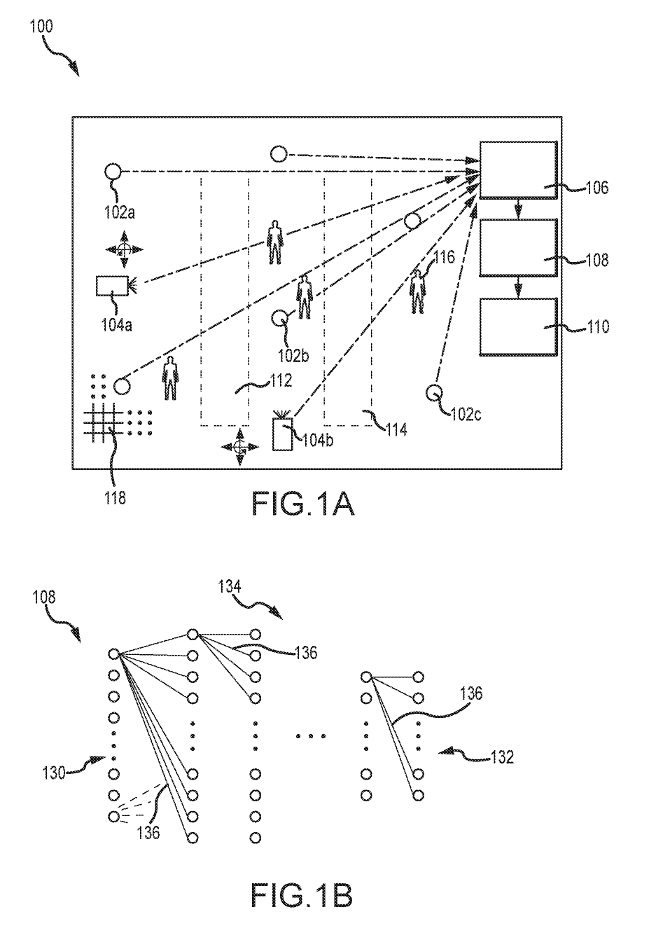

In various embodiments, a system includes a plurality of microphones and one or more cameras operably connected to a processor having deep learning capabilities, such as, for example, a multi-layer artificial neural network. Referring to FIGS. 1A and 1B, for example, a system 100, in accordance with various embodiments, is illustrated as an application in a retail environment. In various embodiments, the system 100 includes a plurality of microphones distributed around a store, including a first microphone 102a, a second microphone 102b and a third microphone 102c. The system 100 further includes one or more cameras, including a first camera 104a and a second camera 104b. In various embodiments, the cameras may be video cameras, configured to capture video streams, or may be single-shot cameras, configured to capture single images. In various embodiments, the one or more cameras may be motorized in order to translate or rotate with respect to a fixed point within the retail environment. In various embodiments, the ability to translate or rotate one or more of the one or more cameras aids in acquiring and providing accurate location information to the system for training when the one or more cameras are not then-currently focused on a location of a sound source. In various embodiments, the system 100 includes a pre-processor 106 for filtering and categorizing audio signals, an artificial neural network 108 configured for deep learning capabilities and for processing one or more outputs based on a series of inputs and a post-processor 110 configured for subsequent processing of the outputs of the artificial neural network. As illustrated, the store may include one or more shelves 112, one or more refrigerators 114 and one or more individuals 116 moving about the store. In various embodiments, the system 100 may be configured to monitor equipment health or the movement or characteristics (e.g., purchasing desires) of humans in high-foot traffic areas, such as crowded retail environments.

In various embodiments, the system 100 may be trained to provide a precise location of an event based on audio signals input to the artificial neural network 108. In various embodiments, for example, the artificial neural network 108 may comprise an input layer 130, an output layer 132 and a plurality of hidden layers 134. In various embodiments, a plurality of connections 136 interconnects the input layer 130 and the output layer 132 through the plurality of hidden layers 134. In various embodiments, a weight is associated with each of the plurality of connections, the weight being adjustable during the training process. In various embodiments, the artificial neural network 108 may be configured to receive as inputs audio signals from the plurality of microphones, including the first microphone 102a, the second microphone 102b and the third microphone 102c. In various embodiments, the first microphone 102a, the second microphone 102b and the third microphone 102c are positioned about the environment and configured to triangulate the location of a sound source. Precise location information is also input to the artificial neural network based on images taken by the one or more cameras, including the first camera 104a and the second camera 104b. In various embodiments, a grid system 118 may be positioned about the environment, for example, on the floor, to aid the one or more cameras in determining the location information. Training of the artificial neural network 108 may then proceed by entering the audio signals at the input layer 130 of nodes of the artificial neural network 108 and using the location information provided by the cameras to compute an error at the output layer 132. The error is then used during backpropagation to train the weights associated with each of the plurality of connections 136 interconnecting the input layer 130, the plurality of hidden layers 134 and the output layer 132. In various embodiments, the training may occur continuously following installation of the system 100 at a location such as a retail environment.

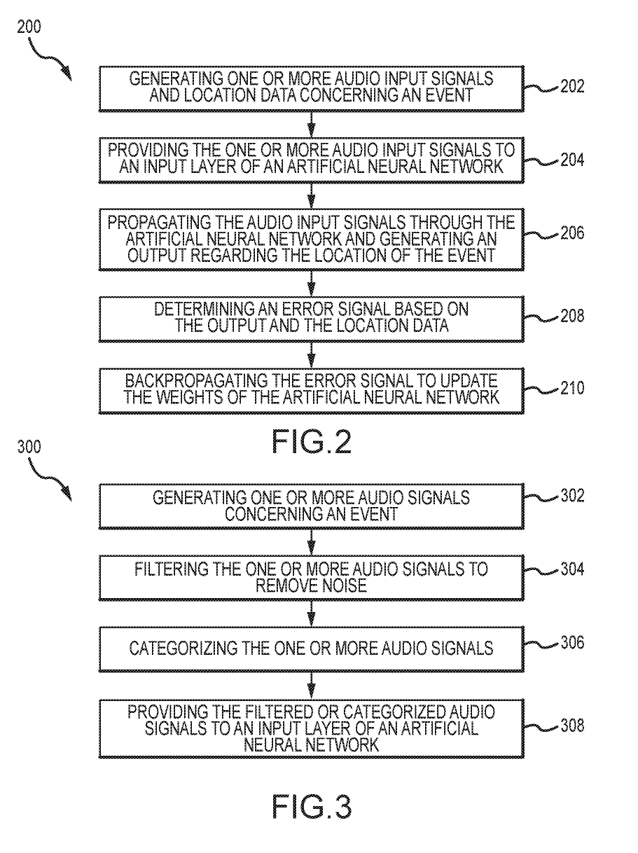

Referring now to FIG. 2, a method 200 is described for using a system having an artificial neural network, such as the system 100 described above with reference to FIG. 1, to identify a sound and its location within an environment to be monitored. In accordance with various embodiments, the method 200 includes a first step 202 of generating one or more audio input signals and location data concerning an event occurring within the environment to be monitored. In various embodiments, the one or more audio input signals is generated by a plurality of microphones distributed about the environment to be monitored, such as, for example, the retail environment described above with reference to FIG. 1. In various embodiments, the one or more audio input signals may be filtered using signal processing techniques to reduce noise associated with, for example, reflections (e.g., off of shelves or walls) or background noise. In various embodiments, the location data is determined by one or more cameras placed within the environment to be monitored. In a second step 204, the one or more audio signals is input to an input layer of an artificial neural network, such as, for example, the input layer 130 of the artificial neural network 108 described above with reference to FIG. 1B. In a third step 206, the one or more audio signals are propagated through the various layers of the artificial neural network and an output is generated at an output layer of the artificial neural network, such as, for example, the output layer 132 described above with reference to FIG. 1B. In a fourth step 208, an error value is determined based on the output generated at the output layer and the location data. In a fifth step 210, the error value is used to update the weights of the artificial neural network using a backpropagation algorithm. In various embodiments, the process is continually repeated to continuously train and update the weights of the artificial neural network.

Referring now to FIG. 3, a method 300 is described for preprocessing audio signals in a system having an artificial neural network, such as the system 100 described above with reference to FIG. 1, prior to their input to the artificial neural network. In accordance with various embodiments, the method 300 includes a first step 302 of generating one or more audio signals concerning an event occurring within an environment to be monitored. In a second step 304, the one or more audio signals is filtered to remove detectable and undesirable noise, including noise due to reflections from surfaces and any background environments. In a third step 306, the one or more audio signals are categorized based on the nature of the sound. For example, audio signals containing human voice data may be analyzed to determine whether the human is male or female. Additionally, the audio signals may be categorized based on recognition of sounds consistent with, for example, (i) motors, such as the motors running refrigerators, (ii) breakage, such as might occur when a glass jar is dropped on a floor, or (iii) speech recognition, such as phrases associated with a need for assistance or recognition that a product is out of inventory. In a fourth step 308, the filtered or categorized audio signals, together with location data, may be input to the artificial neural network, in a fashion similar to that above described, and used to train the network to recognize the various categories of sound and the location(s) from which the sounds occur or emanate.

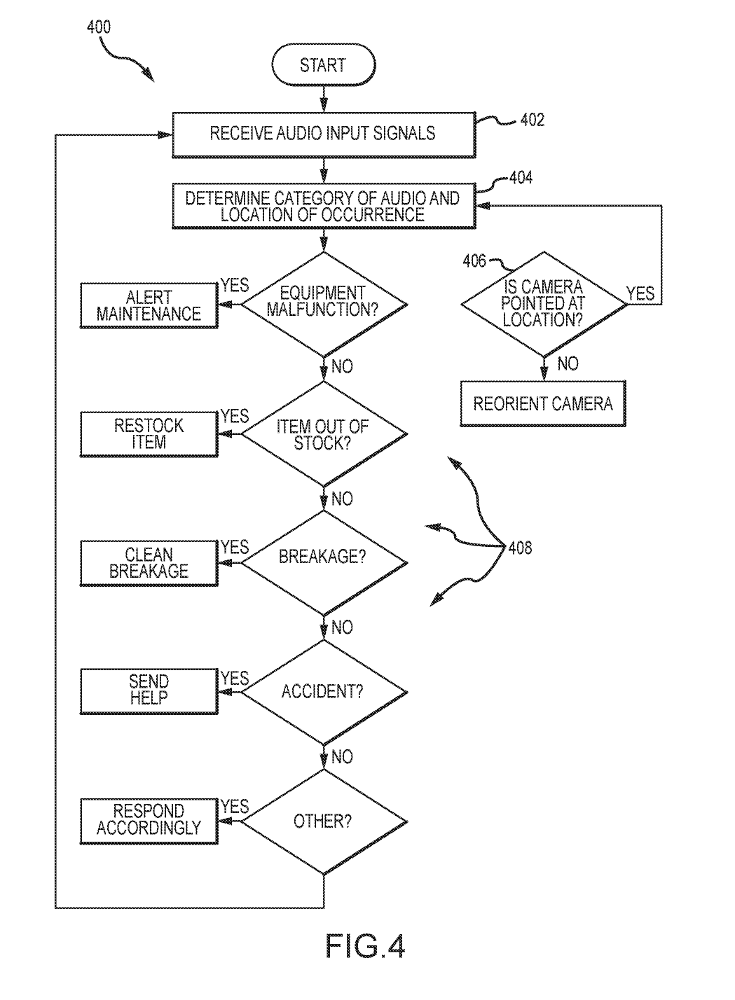

Referring now to FIG. 4, a flowchart 400 is provided to describe various operations executed by a system having an artificial neural network, such as the system 100 for a retail environment described above with reference to FIG. 1, that has been at least partially trained according to the methods described above with reference to FIGS. 2 and 3. Following activation or starting of the system, in a first operation 402, one or more audio signals is received by the artificial neural network. In various embodiments, the one or more audio signals is generated by one or more of a plurality of microphones distributed throughout the retail environment. In a second operation 404, the artificial neural network determines a category of the sound represented by the one or more audio signals and the location of the source of the sound. Following determination of the category of the sound and the location of the source of the sound, a third operation 406 determines whether a camera is pointed at the location of the source of the sound. If not, one or more of the cameras having motorized features for translation or rotation is reoriented to point at the location of the source of the sound. In various embodiments, a post-processor, such as, for example, the post-processor 110 described above with reference to FIG. 1, may control the reorientation of the one or more cameras.

Simultaneously, following determination of the category of the sound and the location of the source of the sound, a fourth operation 408 determines and controls the response of the system depending on the categorization of the sound and the location of its source. For example, if the category of the sound is an equipment malfunction—e.g., a refrigerator malfunction—then an output signal may be generated that is used to alert a maintenance service to repair the refrigerator. If the category of the sound is a customer uttering that an item is out of stock, then an output signal may be generated that is used to alert an employee to take the necessary steps to restock the item. If the category of the sound is a breakage, such as a glass jar, then an output signal may be generated that is used to alert an employee to take the necessary steps to clean up the breakage. If the category of the sound is an accident, such as a slip and fall, then an output signal may be generated that is used to alert an employee to take steps necessary to assist the victim of the accident. As indicated, detection of other sounds not expressly identified above may be trained into the system with corresponding signals generated to enable proper response. In various embodiments, a post-processor, such as, for example, the post-processor 110 described above with reference to FIG. 1, may control the query and subsequent response to identification of the sound and the location of its source.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system for monitoring an environment, comprising:
an artificial neural network;
a plurality of microphones positioned about the environment, the plurality of microphones configured to feed one or more audio signals to an input layer of the artificial neural network; and
a first camera positioned within the environment, the first camera configured to determine location data for input to the artificial neural network.

2. The system of claim 1, wherein the plurality of microphones includes at least three microphones configured to triangulate a location of a sound source.

3. The system of claim 2, wherein the first camera is configured to translate with respect to a point of reference within the environment.

4. The system of claim 3, wherein the location data is used to determine an error signal.

5. The system of claim 4, wherein the artificial neural network is configured to use the error signal in a backpropagation procedure.

6. The system of claim 5, further comprising a second camera positioned within the environment, the second camera configured to determine second-location data for input to the artificial neural network.

7. The system of claim 1, further comprising a pre-processor configured to filter noise from the one or more audio signals.

8. The system of claim 7, wherein the artificial neural network is configured to identify a sound event and a location of the sound event within the environment.

9. The system of claim 8, further comprising a post-processor configured to generate response signals in response to identification of the sound event and the location of the sound event.

10. The system of claim 9, wherein the sound event is originated from at least one of a refrigeration unit, a product breakage occurrence or a human utterance or movement.

11. The system of claim 9, wherein the post-processor is configured to reorient the first camera in response to identification of the sound event and the location of the sound event.

12. The system of claim 11, wherein the first camera is configured to rotate or translate with respect to a point of reference within the environment.

13. A method for training an artificial neural network to identity a source of sound and a location of the source of sound within an environment, comprising:
generating an audio signal representing the source of sound and the location of the source of sound;
providing the audio signal to an input layer of the artificial neural network;
propagating the audio signal through the artificial neural network and generating an output signal regarding the source of sound and the location of the source of sound;
determining an error signal based on the output signal and location data concerning the location of the source of sound; and
backpropagating the error signal to update a plurality of weights within the artificial neural network.

14. The method of claim 13, wherein generating the audio signal representing the source of sound and the location of the source of sound comprises receiving a plurality of audio signals from a plurality of microphones positioned within the environment.

15. The method of claim 14, wherein the location data is determined by a camera positioned within the environment.

16. The method of claim 15, wherein the camera is configured to translate with respect to a point of reference within the environment.

17. The method of claim 13, wherein the error signal comprises information based on the source of sound.

18. A system for monitoring an environment, comprising:
a data processor, including an artificial neural network, a pre-processor to the artificial neural network and a post-processor;
a plurality of microphones positioned about the environment, the plurality of microphones configured to feed one or more audio signals to the pre-processor to filter the one or more audio signals prior to being fed to an input layer of the artificial neural network; and
a first camera positioned within the environment, the first camera configured to determine location data for input to the artificial neural network.

19. The system of claim 18, wherein the location data is used to determine an error signal and wherein the artificial neural network is configured to use the error signal in a backpropagation procedure.

20. The system of claim 19, wherein the artificial neural network is configured to identify a sound event and a location of the sound event within the environment and wherein the post-processor is configured to generate response signals in response to identification of the sound event and the location of the sound event.
